(19) United States
(12) Patent Application Publication
(10) Pub. No.: US 2017/0266688 A1
(43) Pub. Date: Sep. 21, 2017

(54) A DEPOSITING APPARATUS

(71) Applicant: Thomas William Lindsay, East Blaxland (AU)

(72) Inventor: Thomas William Lindsay, East Blaxland (AU)

(21) Appl. No.: 15/505,553

(22) PCT Filed: Aug. 20, 2015
(86) PCT No.: PCT/AU2015/051478

§ 371 Date: Feb. 21, 2017

(30) Foreign Application Priority Data
Aug. 21, 2014 (AU) 2014903279
Jun. 22, 2015 (AU) 2015902402

(51) Int. Cl. B05C 11/02; A21C 15/00; B05C 1/02

(52) U.S. Cl. CPC B05C 11/023; B05C 1/02; A21C 15/007

(57) ABSTRACT

A depositing apparatus for depositing a filler substance, the apparatus including: a housing including a filler inlet and a filler outlet; a rotor member configured to rotate within the housing, the rotor member including at least one passage extending therethrough, between at least two passage openings, such that rotation of the rotor member moves at least one of the at least two passage openings into and out of alignment with the filler inlet and filler outlet; and a piston member positioned within the at least one passage that moves with rotation of the rotor member.

### FIELD OF THE INVENTION

The present invention relates to depositing apparatus, and in particular, to depositing apparatus for depositing food fillings, such as pie fillings.

### BACKGROUND

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Industrial depositing machines for injecting pie fillings are often large, complicated and difficult to clean. The pie filling itself is inherently sticky and often adheres to the components of traditional filling depositors. For example, in depositors that employ the use of pistons, pie filling often adheres to the depositing end of the pistons. This may lead to inconsistent amounts of filling being deposited, with some pies having more filling than others. It is clear how this may be a problem for pie vendors looking to deliver a consistent high quality product.

The present invention seeks to address at least some of the problems associated with existing depositing apparatus.

### SUMMARY OF THE INVENTION

In one broad from the present invention provides a depositing apparatus for depositing a filler substance, the apparatus including: a housing including a filler inlet and a filler outlet; a rotor member configured to rotate within the housing, the rotor member including at least one passage extending therethrough, between at least two passage openings, such that rotation of the rotor member moves at least one of the at least two passage openings into and out of alignment with the filler inlet and filler outlet; and a piston member positioned within the at least one passage that moves with rotation of the rotor member.

In one form, the piston member moves to allow space for filler substance to enter the passage and to expel received filler substance from the passage.

In one form, the rotor member is substantially barrel shaped.

In one form, the at least one passage extends substantially perpendicular to the axis of rotation of the rotor member between two opposite passage openings.

In a further form, the at least one passage extends along a diameter of the rotor member between two opposite passage openings.

In one form, the two opposite passage openings of are offset by 180° around the rotor member.

In another form, the housing has a cylindrical inner cavity configured to fit the barrel shaped rotor member.

In one form, the filler inlet and outlet are formed of one or more openings in the housing that lead into the cavity.

In a further form, the housing is of substantially tubular shape.

In one form, the rotor member includes a plurality of passages extending therethrough, each including a respective piston member therein.

In another form, the at least one passage and piston member therein are shaped to allowing sliding movement of the piston member within the passage and limit rotational movement of the piston member within the passage.

In a further form, the piston member is substantially elongate having two ends.

In one form, the piston member is substantially cylindrical.

In another form, the piston member is substantially cylindrical but has at least one edge extending in the axial direction along its curved surface.

In one form, the at least one passage and piston member therein have corresponding axial cross-sections the shape of a major segment of a circle.

In another form, the at least one passage and piston member therein have corresponding axial cross sections the shape of a circle having one or more minor segments removed.

In a further form, the ends of the piston member are curved.

In another form, the ends of the piston member are arcuate and have a radius of curvature that corresponds to the radius of curvature of the rotor member.

In one form, the ends of the piston member move into and out of alignment with the at least two passage openings to intermittently occupy the passage openings.

In one form, the ends of the piston member are shaped such that when an end of the piston member aligns with a passage opening, the piston end and surface of the rotor member form a substantially smooth continuous surface.

In a further form, the filler inlet is upward facing and the filler outlet is downward facing such that as a first of the passage openings aligns with the filler inlet, gravity acts to move the piston member downward towards a second of the passage openings, opposite the first, to allow space for filler substance to enter the passage via the first opening.

In one form, the piston member in the at least one passage moves to simultaneously allow space for filler substance to enter the passage at a first of the at least two passage openings and to expel received filler substance from a second of the at least two passage openings, opposite the first.

In one form, the apparatus further includes a support to hold the housing such that the filler inlet is substantially upward facing and the filler outlet is substantially downward facing.

In another form, the apparatus further includes a drive means configured to rotate the rotor member.

In one form, the depositing apparatus includes a control system for controlling the drive means in accordance with a pre programmed rotation sequence.

In another form, the pre-programmed rotation sequence includes a wipe rotation sequence.

In one form, the wipe rotation sequence includes rotation of the barrel in a back and forth movement.

In a further form, the wipe rotation sequence includes, after aligning a passage opening with the filler outlet, rotating the barrel in a first direction until the passage opening is at least partially misaligned with the filler outlet, and then rotating the barrel in a second direction, opposite the first direction.

In one form, the wipe rotation sequence includes, after aligning a passage opening with the filler outlet, rotating the barrel in a first direction until the passage opening is at least completely misaligned with outlet, and then rotating the barrel in a second direction, opposite the first direction.

In another form, the apparatus further includes a hopper connected to the filler inlet to receive and feed filler substance to the filler inlet.

In a further broad form, the present invention provides a piston member for use in a depositing apparatus as described in the above forms, the piston member being substantially cylindrical but having the cross section of the major segment of a circle.

In another broad form, the present invention provides piston member for use in a depositing apparatus as described in the above forms, the piston member having an axial cross section the shape of a circle having one or more minor segments removed.

In one form, the ends of the piston member are curved.

In another form, the ends of the piston member are arcuate.

In one form, the ends of the piston member have a radius of curvature of about 60 to 80 mm.

In another form, the ends of the piston member have a radius of curvature of about 75 mm.

It will be appreciated the term rotor member would be understood in the context of this specification to be relating to any part that rotates during operation of an apparatus, machine, device or the like.

### BRIEF DESCRIPTION OF THE DRAWINGS

This invention may be better understood with reference to the illustrations of embodiments of the invention in which:

FIG. 1 is an exploded view of a depositing apparatus according to one example of the invention;

FIG. 2a is a perspective view of a piston member according to one example;

FIG. 2b is a top view of the piston member in FIG. 2a;

FIG. 2c is a side view of the piston member in FIG. 2a;

FIG. 3a is a top view of a further example of a piston member;

FIG. 3b is a side view of the piston member in FIG. 3a;

FIG. 4a is a top view of a rotor barrel suitable for use with the piston member shown in FIG. 3a; and

FIGS. 4b and 4c show end views of the rotor barrel in FIG. 4a.

### DETAILED DESCRIPTION

Embodiments of the invention provide a depositing apparatus suitable for depositing a filler substance such as, for example, a food filling. The depositing apparatus may be used, for example, to consistently deposit a set amount of food filling onto a conveyer line. It will however be appreciated that the depositing apparatus may also be used for other purposes, such as the deposition of other materials/substances/compositions.

The depositing apparatus includes a housing with a filler inlet and a filler outlet, and a rotor member configured to rotate within the housing. The rotor member includes at least one passage extending therethrough, between at least two passage openings. Rotation of the rotor member moves at least one of the at least two passage openings into and out of alignment with the filler inlet and filler outlet. The rotor member is typically barrel shaped or substantially barrel shaped.

A piston member positioned within the at least one passage moves with rotation of the rotor member. Generally, the piston member moves to allow filler substance to enter the passage when one of the passage openings align with the filler inlet and to expel received filler substance from the passage when one of the passage openings align with the filler outlet.

In most instances, this happens simultaneously as the at least one passage typically extends between two opposite openings offset by 180° around the rotor member. As such as one of the passage openings is aligned with the filler inlet, the other of the openings is aligned with the filler outlet. Intake/expulsion of filler substance is thus simultaneous as when the piston member moves to allow space in the passage for filler substance to enter from the filler inlet, filler substance is pushed from the opposite passage opening out the filler outlet.

The rotor member (barrel shaped or otherwise) typically includes a plurality of passages extending therethough, each including a respective piston member. This increases productivity as multiple filling deposits can be made simultaneously as the barrel rotates.

Typically, the filler inlet is substantially upward facing and the filler outlet is substantially downward facing and the piston member/s slide along the passage/s under the force of gravity as the rotor member rotates. Although, it will be appreciated that in alternate forms, the piston members may be moved by means other than gravity.

The piston members are specially shaped to minimize adherence of filler substance during filler deposition. For example, the piston member/s are typically shaped to allow sliding movement of the piston member within the passage yet limit rotational movement of the piston member within the passage. This helps to avoid filler substance getting trapped between the inner wall of the passages and the pistons. In one example, the piston members generally have an axial cross section the shape of a circle having one or more minor segments removed. The piston members also typically have curved end surfaces which encourages filler adhered to end of the piston/s is wiped off (e.g. against the filler outlet) as the barrel rotates.

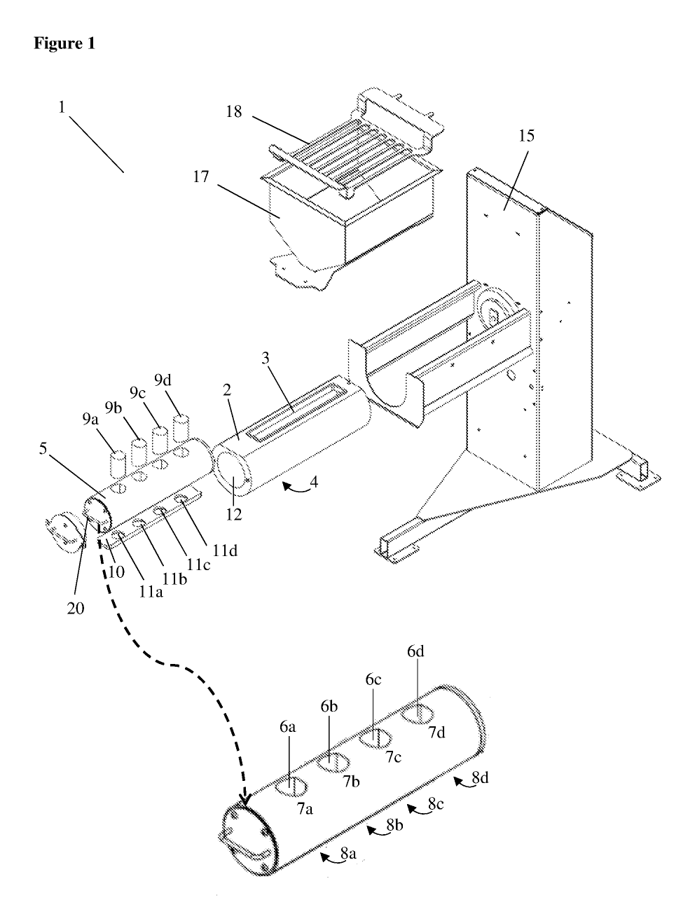

FIG. 1 shows one example of a depositing apparatus in accordance with the invention. The apparatus (1) is for depositing fillings into pies. However, it will be appreciated that the depositing apparatus in accordance with the invention may be used for other purposes.

The apparatus (1) includes a housing (2) having a filler inlet (3) and a filler outlet (4/not shown). A barrel/rotor member (5) fits and rotates within the housing (2). The housing (2) has a substantially cylindrical inner cavity (12) to accommodate the barrel (5). The filler inlet (3) and outlet (4) are openings in the housing that lead into the cavity (12).

In the example of FIG. 1, the barrel includes four passages (6a, 6b, 6c and 6d) extending therethrough. It will be appreciated that in other embodiments the barrel may include any number of passages. Each passage (6a-d) extends between two passage openings (7a/8a, 7b/8b, 7c/8c, 7d/8d) in the curved surface of the barrel. The barrel (5) rotates within the housing (2) such that the passage openings (7a-d, 8a-d) move into an out of alignment with the filler inlet (3) and the filler outlet (4).

Within each passage (6a-d) is a piston member (9a, 9b, 9c, 9d) that moves within the passage with rotation of the barrel (5). The pistons (9a-d) are typically of a length shorter than the passages such that they slide within the passages, between passage openings, as the barrel (5) is rotated. This provides space for filler substance to enter the passages (6a-d) through the filler inlet (3).

In this example, the passages (6a-d) extend perpendicular to the axis of rotation of the barrel along a diameter of the barrel (5). This configuration allows that filler substance can be received from the passage openings (e.g. 7a-d) on one side of the barrel (5) whilst filler substance is simultaneously expelled from the passage openings (e.g. 8a-d) at the opposite side of the barrel (5).

The filler inlet (3) is substantially upward facing and the filler outlet (4) is substantially downward facing. Therefore, as the passage openings on one side of the barrel (e.g. 7a-d) align with the filler inlet (3), gravity acts to move the piston members (9a-d) downwards towards the other passage openings on the opposite side of the barrel (e.g. 8a-d). This allows space for the filler substance to enter the passage via the passage openings (e.g. 7a-d) near to the filler inlet (3).

At the same time, any filler substance in the passages on the other side of the pistons, near to the filler outlet (4), is expelled by the pistons. In this way, the piston members move with rotation of the barrel to simultaneously allow the filler substance to enter the passages via the passage openings on one side of the barrel while expelling filler substance via the passage openings on the other side of the barrel.

It will be appreciated that each set of passage openings (e.g. 7a-d, 8a-d) repeatedly align with the inlet to receive filler substance and then align with the outlet for expulsion (4). The pistons always moving downward with gravity at the beginning of the intake/expulsion stage in the deposition cycle when they are at relative upper position in the barrel, near to the inlet. Generally, there is a pause in rotation to allow intake/expulsion of filler substance.

It will be appreciated that in alternate embodiments, the pistons may not move under the force of gravity but may be controlled by other means, such as mechanical/electrical/pneumatic/hydraulic means.

A retainer plate (10) sits within the filler outlet (4) dividing the outlet (4) to into multiple openings (11a-d). The openings (11a-d) of the retainer plate are sized to stop the pistons (9a-d) falling from the passages out of the filler outlet (4). For example, the retainer plate (10) typically includes openings having a circumference or cross sectional area slightly less than the pistons. It will be appreciated by a person skilled in the art that the filler inlet (3), outlet (4), and retainer plate (10) may have a variety of configurations. For example, each may include a single or multiple openings. Furthermore, in some forms, a retainer plate may not be included with the outlet itself shaped to prevent escape of the pistons.

Furthermore, the length of the pistons, passages and/or diameter of the barrel may be variable to allow for different amounts of filler substance to be received by the passages with each deposition cycle. In this way the amount of deposited filling may be adjusted.

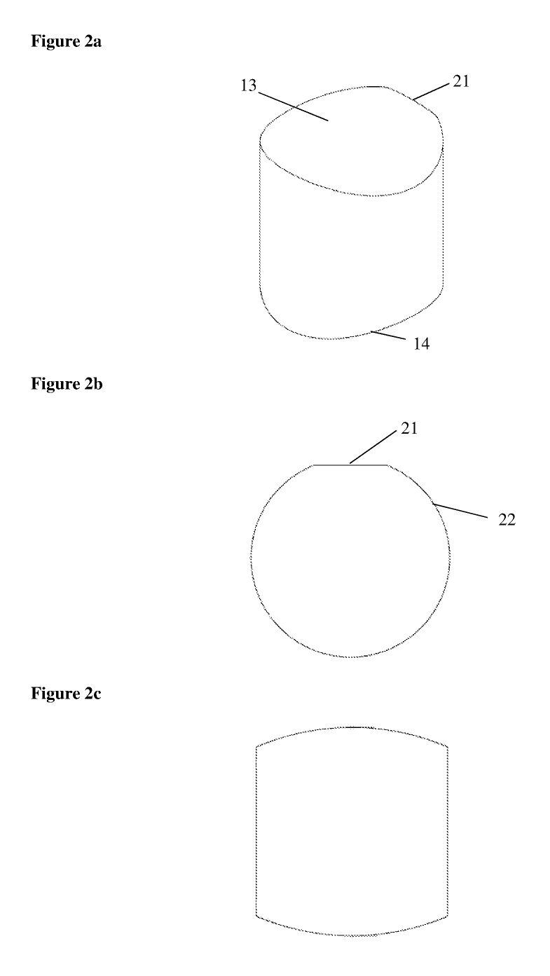

Although the passage and piston members positioned therein are shaped to allow sliding movement of the piston members within the passages, they are typically shaped to limit rotational movement of the piston members within the passages. This helps to stop filler substance from getting stuck between the pistons and inner walls of the passages. In the example of FIG. 1, the passages and piston members have a cross-section the shape of a major segment of a circle (see FIGS. 2a-2c). The edges between the flat face (21) and curved surface (22) of the pistons engage with the passage walls to substantially prohibit rotational movements of the pistons.

In addition the ends (13, 14) of each piston member (9a-d) are curved. They are arcuate and have a radius of curvature that corresponds to the radius of curvature of the rotor member/barrel. This ensures that when a piston end moves toward and occupies a passage opening (e.g. 7a-d, 8a-d), such as shortly after expelling filler substance from the passages, the end of the piston member and barrel outer surface form a substantially continuous smooth surface. This helps to ensure that minimal if any filler substance remains adhered to the end of the piston after deposition as any adhered filler substance is wiped against the rim of the filler outlet or retainer plate as the barrel rotates.

To the contrary, if the ends of the pistons were flat, any filler substance adhering to the piston end would sit just below the outer surface of the barrel and would not get wiped away with subsequent rotation of the barrel. This can lead to inconsistencies in deposited filling amounts.

In one particular example, the radius of curvature of the ends of the pistons is between 60 and 80 mm. In another example, the radius of curvature is about 75 mm.

A support or frame (15) supports the housing (2) such that the filler inlet (3) is substantially upward facing and the filler outlet (4) is substantially downward facing. In some embodiments the support (15) may include wheels to move the apparatus into and out of a working position, such as, for example, over a conveyer belt carrying pie pastry/bases.

Generally, a drive means is configured to rotate the rotor barrel and may, for example, include a motor. The operation of the drive means may be controlled using a control/processing system (e.g. including controller, microcontroller, computer system, suitably designed circuitry etc.). The control/processing system is typically configured such that the barrel is automatically rotated in accordance with one or more pre programmed rotation sequences. It will be appreciated that control/processing system may control the barrel/rotor member rotation in a variety of ways such as, for example, rotation direction, speed, and/or time. It will also be appreciated that in basic forms or modes of operation the barrel rotated using handle (20).

A hopper (17) is included to aid in loading filler substance and is connected above the filler inlet (3) such that filler substance moves into the passages under the force of gravity. A safety grate (18) may also be included on top of the hopper (17). The apparatus may be configured that opening the safety grate cuts power to the drive means stopping rotation of the barrel (5). This ensures that the barrel (5) is not rotating when a user has the safety grate removed and therefore, reduces the chance of injury to workers.

It will be appreciated that the rotor member/barrel (5) may be rotated in accordance with a variety of operation modes or rotation sequences. For example, the barrel may be rotated in one direction only with pauses when the passage openings (7a-d, 8a-d) align with the filler inlet (3) and outlet (4) to allow for intake and expulsion of filler substance from the passages (9a-d).

Another example may have the barrel (5) continuously moving in a back and forth movement, with a half revolution (e.g. 180°) in one direction and a half revolution in the other direction. In this mode of operation, the passage openings would be aligned to receive/expel filler substance, the barrel rotated 180° in one direction (e.g. to move the passage openings in line with the inlet to be in line with the outlet and vice versa), more filler substance receive/expelled, and then the barrel rotated 180° in the other direction and so on in an overall back and forth movement.

The rotation sequence of the barrel may also include an additional wipe sequence wherein, each time filler substance is deposited, the barrel is rotated in a first direction such that the passage openings are partially or completely offset/misaligned from the outlet and then rotated in the opposite direction passing over the outlet until the passage openings are again partially or completely offset/misaligned from the filler outlet. The wipe sequence thereby encourages any excess filler substance adhered to the end of the pistons to be scraped from the surface of the piston ends by the edge of the filler outlet or retainer plate. It will be appreciated that the wipe sequence may include any number of back and forth movements of the barrel to encourage removal of adhered filler substance.

For example, if the barrel was set to move in an overall clockwise direction, with pauses to receive/deposit filler substance when the passage openings align with the inlet/outlet, a wipe sequence may initiate after each filler deposition. In the wipe sequence, the barrel may rotate counter-clockwise until the passage openings are completely offset from the filler outlet and then continue in the overall clockwise direction. This would ensure that any filler substance adhered to the depositing end of the piston would be wiped against the edge of the outlet/retainer plate. It will be appreciated that the wipe functionality would be further aided by the curved shape of the piston end, which keeps filler substance in line with the circumference of the outer surface of the barrel.

It will also be appreciated that in other embodiments, the passage openings may not be offset by 180°, and correspondingly, the rotational movements of the barrel may not be in 180° steps. The passages themselves may also have bends or corners therein to, for example, inherently slow the flow of filler substance therethrough.

Furthermore, it will also be appreciated that the passages and pistons may take alternate forms from that described in FIGS. 1 and 2. For example, each passage within the barrel may be such that it has more than two openings. For example a passage may have four openings and the piston may be of a cross type shape. Alternatively, a passage may only have a single opening for receiving/expelling filler substance, with second opening simply for allowing air intake/outtake into the passage such that the piston is able to slide within the passage.

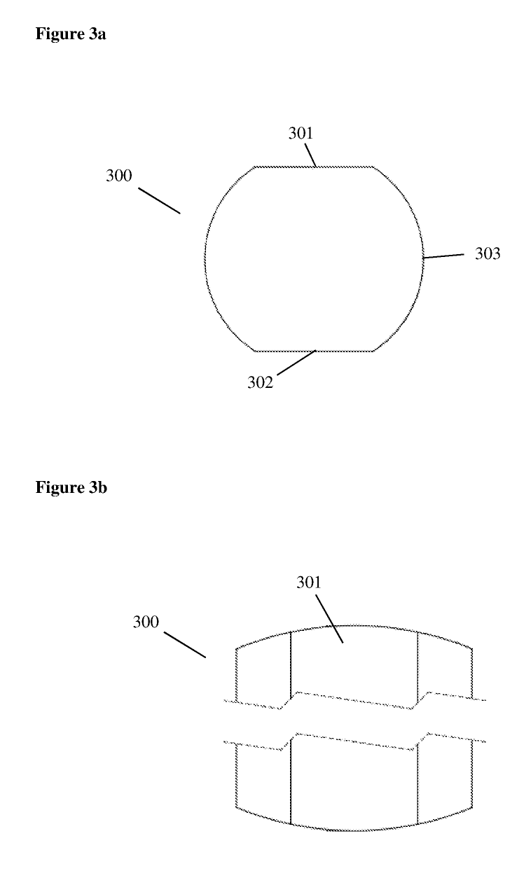

One particular variant on piston shape is shown in FIGS. 3a and 3b. The piston is substantially cylindrical but (300) has two flat faces (301, 302) in its curved surface that result from two secant/chord cuts (i.e. the axial cross section of the piston is a circle with two minor segments removed). It will be appreciated that the piston may be any shape that limits rotation but allows sliding movement within the passages. For a substantially cylindrical piston this typically requires at least one edge in its curved surface in the axial direction. Preferred piston shapes have an axial cross section the shape of a circle with one or more minor segments removed.

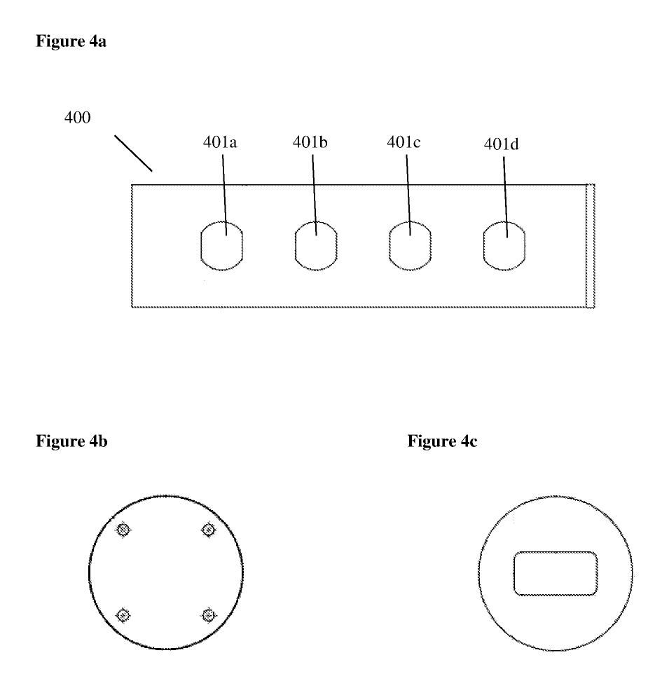

FIG. 4 shows one example of a rotor barrel (400) suitable for use with the piston member (300) of FIG. 3. The cross sections of the passages (401a-d) are configured to fit the shape of the piston (300) (i.e. the passages have a cross section the shape of a circle with two minor segments removed).

It will be appreciated that the passages of the rotor barrel are typically configured to match the required piston shape. It will also be appreciated that the piston shape may not always have a substantially cylindrical base form. For example, they may be prism shaped, such as, for example, square or triangular prism shaped. The pistons may also, for example, have an axial cross section the shape of a circle with one or more sectors removed.

The depositing apparatus as described herein has significant advantages over conventional depositing devices. In particular, the apparatus is simple with minimal moving parts, which allow it to be easily disassembled for cleaning purposes or maintenance. Furthermore, the configuration/shape of the piston, rotor member and housing allow for a high level of consistency of deposited amounts of filler substance.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

It will be appreciated that various forms of the invention may be used individually or in combination.

1. A depositing apparatus for depositing a filler substance, the apparatus including:
a housing including a filler inlet and a filler outlet;
rotor member configured to rotate within the housing, the rotor member including at least one passage extending therethrough, between at least two passage openings, such that rotation of the rotor member moves at least one of the at least two passage openings into and out of alignment with the filler inlet and filler outlet; and
a piston member positioned within the at least one passage that moves with rotation of the rotor member,
wherein the at least one passage and piston member therein are shaped to allow sliding movement of the piston member within the passage and limit rotational movement of the piston member within the passage.

2. (canceled)

3. A depositing apparatus as claimed in claim 1, wherein the rotor member is substantially barrel shaped.

4. (canceled)

5. A depositing apparatus claimed in claim 1, wherein the at least one passage extends along a diameter of the rotor member between two opposite passage openings.

6. (canceled)

7. A depositing apparatus as claimed in claim 1, wherein the housing has a cylindrical inner cavity configured to fit the barrel shaped rotor member.

8. A depositing apparatus as claimed in claim 1, wherein filler inlet and outlet are formed of one or more openings in the housing that lead into the cavity.

9. A depositing apparatus as claimed in claim 1, wherein the housing is of substantially tubular shape.

10. A depositing apparatus as claimed in claim 1, wherein the rotor member includes a plurality of passages extending therethrough, each including a respective piston member therein.

11. (canceled)

12. A depositing apparatus as claimed in claim 1, wherein the piston member is substantially elongate having two ends, and the ends of the piston member are curved.

13. (canceled)

14. A depositing apparatus as claimed in claim 1, wherein the piston member is substantially cylindrical but has at least one edge extending in the axial direction along its curved surface.

15. A depositing apparatus as claimed in claim 1, wherein the at least one passage and piston member therein have corresponding axial cross-sections the shape of a major segment of a circle.

16. A depositing apparatus as claimed in claim 1, wherein the at least one passage and piston member therein have corresponding axial cross sections the shape of a circle having one or more minor segments removed.

17. (canceled)

18. A depositing apparatus as claimed in claim 11, wherein the ends of the piston member are arcuate and have a radius of curvature that corresponds to the radius of curvature of the rotor member.

19. (canceled)

20. A depositing apparatus as claimed in claim 1, wherein the ends of the piston member are shaped such that when an end of the piston member aligns with a passage opening the piston end and surface of the rotor member form a substantially smooth continuous surface.

21. A depositing apparatus as claimed in claim 1, wherein the filler inlet is upward facing and the filler outlet is downward facing such that as a first of the passage openings aligns with the filler inlet, gravity acts to move the piston member downward towards a second of the passage openings, opposite the first, to allow space for filler substance to enter the passage via the first opening.

22. (canceled)

23. A depositing apparatus as claimed in claim 1, further including a support to hold the housing such that the filler inlet is substantially upward facing and the filler outlet is substantially downward facing.

24. (canceled)

25. A depositing apparatus as claimed in claim 1, further including a drive means configured to rotate the rotor member and a control system for controlling the drive means in accordance with a pre-programmed rotation sequence.

26. A depositing apparatus as claimed in claim 25, wherein the pre-programmed rotation sequence includes a wipe rotation sequence.

27. A depositing apparatus as claimed in claim 26, wherein the wipe rotation sequence includes rotation of the barrel in a back and forth movement.

28. (canceled)

29. A depositing apparatus as claimed in claim 26, wherein the wipe rotation sequence including, after aligning a passage opening with the filler outlet, rotating the barrel in a first direction until the passage opening is at least completely misaligned with outlet, and then rotating the barrel in a second direction, opposite the first direction.

30. A depositing apparatus as claimed in claim 1, further including a hopper connected to the filler inlet to receive and feed filler substance to the filler inlet.

31. (canceled)

32. (canceled)

33. (canceled)

34. (canceled)

35. (canceled)

36. (canceled)
